(19) United States
(12) Patent Application Publication
(10) Pub. No.: US 2009/0159824 A1
(43) Pub. Date: Jun. 25, 2009

(54) POPPET VALVES

(76) Inventors: Matthew H. Tibbitts, Windsor (GB); Martin G. Edwards, Bracknell (GB); Adrian N.M.I Svensson, Maidenhead (GB)

Correspondence Address: NIXON & VANDERHYE, PC, 901 NORTH GLEBE ROAD, 11TH FLOOR, ARLINGTON, VA, 22203, US

(21) Appl. No.: 12/089,631

(22) PCT Filed: Sep. 1, 2006
(86) PCT No.: PCT/GB2006/003235

§ 371 Date: Jun. 24, 2008

(30) Foreign Application Priority Data
Oct. 21, 2005 (GB) 0521445.7

(51) Int. Cl. F16L 29/02; F16K 15/02

(52) U.S. Cl. 251/148; 137/538

(57) ABSTRACT

A subsea coupler has an internal chamber (6) adapted for the reception of fluid under pressure, a passageway (7) for the ingress of fluid to the chamber, a valve seat (9) in the passageway, a poppet comprising a body (4) which is engageable with the valve seat to close the passageway and a head (3) which fits against the body and is moveable away from the body. The body (4) includes a channel (11, 12) for communicating fluid pressure from the internal chamber to a region between the head and the body whereby the head can be moved away from the body to relieve pressure in the chamber while the body is in engagement with the valve seat.

### FIELD OF TEE INVENTION

This invention relates to poppet valves and is particularly though not necessarily exclusively concerned with poppet valves that are employed in couplings for high-pressure fluid lines such as hydraulic lines, and more particularly to poppet valves employed in subsea couplers.

### BACKGROUND OF THE INVENTION

It is, in the context of subsea couplers, common to provide a poppet valve in each of a pair of mating couplers. Typically, one coupler of a pair is mounted, usually in an array of such couplers, on subsea equipment such as a subsea control module and the or each coupler is connected to various hydraulically or other fluid operated devices on the module. The other coupler of the pair, which may be mounted in an array of such couplers, is connected to some high-pressure source of operating fluid. When the couplers of a pair are mated, the poppet valves in them are depressed to allow fluid under pressure to pass between the couplers. It is known for the couplers to be ‘self-sealing’ for example by providing a spring bias or other means which will automatically close the poppet valve when the couplers are disengaged. Normally the couplings have an intermediate seal, which may be a metal ‘C’ ring or a conical metal ring or an elastomeric O-ring, or a combination of such seals.

Designs of such couplers take into account a need to prevent ingress of external fluid, such as sea water, when the main poppet is lifted away from its seat, usually against the force of a spring. It is furthermore desirable, especially when a multiplicity of couplers have to be engaged with the couplers of the respective pairs at the same time, to avoid excessive force when engaging the couplings. Furthermore, especially for self-sealing couplings, it may happen that because the valves seal against their respective seats and the couplers have intermediate seals, the separation of the couplers is inhibited by vacuum suction.

A further problem, to which the present invention is particularly directed, is that which arises owing to the entrapment within the equipment of fluid which has been supplied under high-pressure through the coupling. If for any reason the equipment has to be serviced or recovered, the presence of entrapped fluid under high pressure is potentially very hazardous.

It is known to alleviate this danger by scoring a groove in the surface of a valve poppet so that in effect there is a permanent channel between the poppet and the valve seat. Although this allows hydraulic pressure to dissipate by virtue of leakage through the channel when the poppet valve is closed and the couplers have been disengaged, once the internal pressure falls below that of the surrounding seawater, the channel will allow the ingress of the sea water to the likely serious detriment of the valve and any equipment to which it is connected.

Accordingly, the object of the invention is to provide an improved poppet and therefore an improved valve, particularly for a subsea coupler.

### SUMMARY OF THE INVENTION

The invention provides a valve comprising a poppet and a passageway which includes a valve seat for the poppet, the poppet comprising a body which is engageable with the valve seat to close the passage and a head which is moveable away from the body against a restoring bias, the body including a channel for communicating fluid pressure to a region between the head and the body whereby the head can be moved away from the body while the body is in engagement with the valve seat.

The body of the poppet preferably defines a reverse seat into which the head fits. The reverse seat may be conical in form and the head may be formed to complement the form of the reverse seat.

The head preferably includes a rearward part that extends through the body. A compression spring may be disposed between the rearward part of the head and the body to provide said bias.

The valve is preferably a self sealing valve which includes means for urging the poppet against the valve seat. This means may comprise a spring between a datum defined in said passage and the body of the poppet. The head may have a nose which is depressible to move the poppet away from the valve seat.

In a preferred form of the invention the valve seat is conical and the body of the poppet has a tapered surface complementary to the conical valve seat. The valve seat separates the passageway from a chamber which is adapted to receive fluid under pressure.

The invention also provides a subsea coupler having an internal chamber, a passageway for the ingress of fluid to the chamber, a valve seat in the passageway, a poppet comprising a body which is engageable with the valve seat to close the passageway and a head which fits against the body and is moveable away from the body, the body including a channel for communicating fluid pressure from the internal chamber to a region between the head and the body whereby the head can be moved away from the body to relieve pressure in the chamber while the body is in engagement with the valve seat.

The head preferably has a nose that is depressible on mating of the subsea coupler with a complementary coupler to move the poppet away from the valve seat. The subsea coupler may be a probe and the complementary coupler may comprise a socket for the reception of the probe. Alternatively a poppet according to the invention may be incorporated in a female coupler and the complementary coupler would be a male probe.

The invention also provides a valve poppet comprising a head, a tapered shoulder for close-fitting engagement with a valve seat, and a body extending rearwardly of the shoulder, in which the head is separable from the shoulder and is a close fit in a reverse seat formed in the shoulder, the head extending through the reverse seat to a part moveable within the body, and a bleed channel through the body to the reverse seat. Preferably the valve poppet comprises a spring coupling between the said part and the body to urge the head and reverse seat together.

### BRIEF DESCRIPTION OF THE DRAWINGS

FIG. 1 is a side sectional view mainly of one example of a subsea coupler including a valve and poppet according to the invention.

FIG. 2 is an end sectional view through part of the body of a poppet in the coupler shown in FIG. 1.

FIG. 3 is a simplified sectional view illustrating one phase in the operation of a poppet valve according to the invention.

FIG. 4 is a simplified sectional view illustrating another phase in the operation of a poppet valve according to the invention.

### DETAILED DESCRIPTION

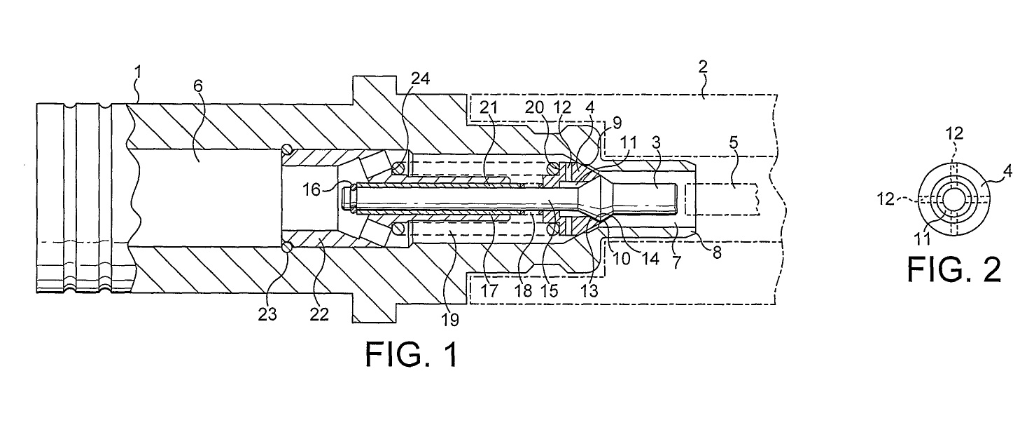

FIG. 1 illustrates in side section a ‘male’ or ‘probe’ coupler 1 which is intended for use with a complementary ‘female’ or ‘socket’ coupler 2. The general configuration of the couplers can be varied quite widely and it is not intended to limit the invention to any particular arrangement of the couplers, their connections or the seals which are commonly disposed between them. Known couplers of this general type are fully described and explained in, for example, U.S. Pat. No. 5,368,070 and U.S. Pat. No. 5,810,047 Both show solid poppet valves engaging conical seats in their respective couplers. In the couplers described in U.S. Pat. No. 5,368,070, the intermediate seal between the couplers is a pressure-responsive annular metal seal with a C-section; there is also another elastomeric seal with a U-section. In the couplers shown in U.S. Pat. No. 5,810,047 patent, the couplers have a conical metal seal which is flattened by a striker when the probe coupler enters the socket coupler. The couplers described in U.S. Pat. No. 5,368,070 and U.S. Pat. No. 5,810,047 are self-sealing, that is to say the heads of the poppets of the valves in the two couplers mutually engage when the pair of couplers is mated, to lift the poppets off their seats and to allow pressurised fluid to flow between the couplers.

In FIG. 1, the female or socket coupler 2 is shown only schematically in a chain outline. The male coupler 1 has a poppet consisting of a head 3 and a body 4 which, as will be described later, are separable. The female coupler 2 has a poppet valve with a head 5 shown in outline. As will be explained later, this poppet in the female coupler 2 may be an ordinary ‘solid’ poppet as described, for example, in U.S. Pat. No. 5,368,070 and U.S. Pat. No. 5,810,047.

The body of the coupler 1 has an internal chamber 6 which at its left-hand end, as shown in the drawing, may be coupled or adapted to be coupled to fluid operated equipment, for example in a subsea control module. This internal chamber 6 leads to a passageway 7 which is defined by a forward hollow tubular extension 8 of the chamber 6. The passageway 7 is delimited from the chamber by a valve seat 9, which in this embodiment of the invention is a conical seat. The body 4 of the poppet has a tapered shoulder 10 which, if the poppet is urged in the direction rightwards as shown in the drawing, seals the internal chamber 6 from the outer part of the passageway 7 and therefore prevents ingress or fluid into the chamber 6 and any line or equipment that is connected to it.

The body 4 of the poppet has a central space 11 from which radiate radial passages 12 which can communicate fluid pressure from the chamber 6 to a reverse seat 13 formed in the body. The head of the poppet is formed separately from the body and has a shoulder 14 which can fit closely against the reverse seat 13 formed in the body. This seat 13 is preferably conical.

The head 3 of the poppet extends rearwardly through the body 4, the rearward part of the head being constituted by a spigot 15 which at its far end is secured by a clip 16 to a sleeve 17 which at its end adjacent the head 3 accommodates by means of a cup 25 (not shown in FIG. 1) a compression spring 18. The purpose of this spring is to urge the head into sealing engagement with the reverse seat. The datum for the spring 18 is the rear surface of the body 4 of the poppet.

The body 4 of the poppet is itself subject to a restoring bias constituted by a spring 19 which urges the body of the poppet and particularly the shoulder 10 into engagement with the main valve seat 9. The compression spring 19 engages a rear shoulder 20 of the body 4 and is supported by a hollow sleeve 21 extending forwardly from an insert 22 within the chamber 6. This cylindrical insert 22 is held in place by a retaining clip 23 between an end shoulder of the insert and a groove in the inner periphery of the chamber 6. The insert 22 provides a shoulder 24 for one end of the main compression spring.

FIG. 2 illustrates the radial passages 12 and the central space 11 in the body 4 of the poppet.

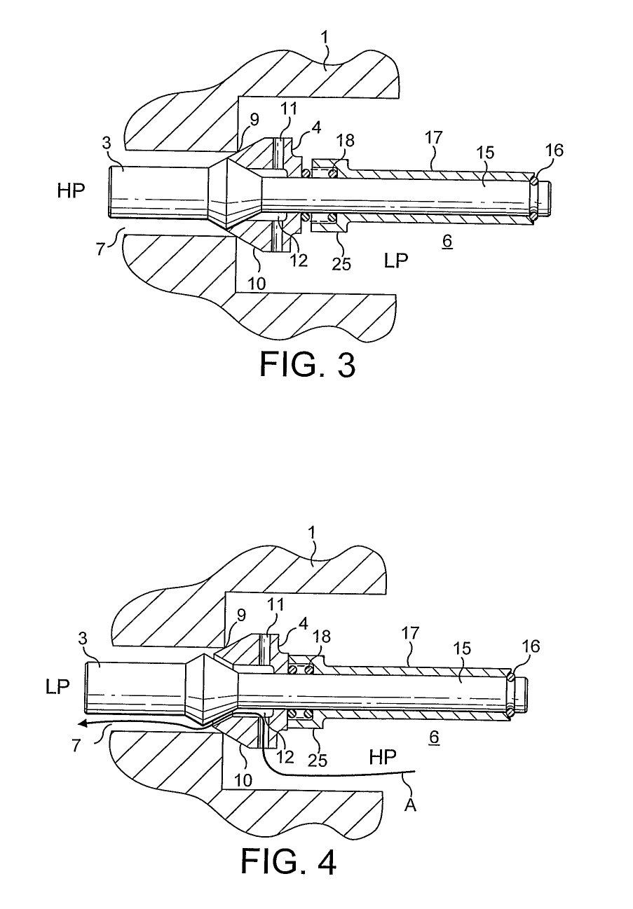

FIG. 3 illustrates the poppet valve, shown the reverse way round purely for convenience. In FIG. 3, the poppet valve is closed, normally being held against the main valve seat 9 by the restoring bias. Furthermore, the head 3 of the poppet is urged against the reverse seat 13 formed in the body 4. In FIG. 3, the left-hand side, at the head of the poppet, is shown as the high-pressure (HP) side whereas the chamber 6 is shown as the low-pressure (LP) side. In normal use, the poppet would be depressed when the coupler in which it is embodied mates with the other coupler of a pair as shown in FIG. 1. The head of the poppet is depressed, against the force of the main spring, to allow fluid to flow from the ‘high-pressure’ side into the chamber 6.

When the couplers are dis-engaged, the poppet valve will return to the position shown in FIG. 3.

The significance of the bleed passages 11 and 12 through the body 4 of the poppet may now be understood. On the assumption that the coupler is disengaged from its mating complementary coupler, the residual high-pressure in the chamber 6 can flow through the radial passages and force the head 3 of the coupler away from the body 4 against the force of the spring 18. Thus there is a bleed flow from the chamber 6 past the head of the coupler as shown by the arrow A. This outflow relieves the excess pressure in the chamber to a value which would be principally determined by the force of the spring 18, which is accommodated by the cup 25 in the sleeve 17.

Thus the pressure in the chamber can be relieved to avoid the previously mentioned hazard. The ingress of the sea-water through the bleed passage can be prevented because the secondary valve formed by the head and body of the poppet will be close by the spring 18.

It will be understood that, particularly where the coupler 2 is connected to the source of pressurised fluid, it is neither necessary nor desirable for the corresponding poppet to be provided with a bleed passage as has been described for the poppet in the coupler 1. In practice therefore the complementary coupler 2 may have a unitary poppet, without the internal bleed passages 11 and 12 and without the spring 18. Such a poppet is illustrated in U.S. Pat. No. 5,368,070 and U.S. Pat. No. 5,810,047.

1-22. (canceled)

23. A valve comprising a poppet and defining a passageway which includes a valve seat for the poppet, said poppet comprising a body which is engageable with said valve seat to close said passageway; and a head which is moveable away from said body against a restoring bias, said body including a channel for communicating fluid pressure to a region between said head and said body whereby said head can be moved away from said body while said body is in engagement with said valve seat.

24. The valve of claim 23 in which said body defines a reverse seat into which said head fits.

25. The valve of claim 24, in which said reverse seat is conical in form and said head is formed to complement said form of said reverse seat

26. The valve of claim 23, in which said head includes a rearward part that extends through said body.

27. The valve of claim 26 and further comprising a compression spring between said rearward part of said head and said body to provide said restoring bias.

28. The valve of claim 23, and further comprising means for urging said poppet against said valve seat.

29. The valve of claim 23, in which said head is depressible to move said poppet away from said valve seat.

30. The valve of claim 23, in which said valve seat is conical and said body of said poppet has a tapered surface complementary to said conical valve seat.

31. The valve of claim 23, in which said valve seat separates said passageway from a chamber which is adapted to receive fluid under pressure.

32. A subsea coupler having an internal chamber, a passageway for the ingress of fluid to said chamber, a valve seat in said passageway, and a poppet comprising a body which is engageable with said valve seat to close said passageway; and a head which fits against said body and is moveable away from said body, said body including a channel for communicating fluid pressure from said internal chamber to a region between said head and said body whereby said head can be moved away from said body to relieve pressure in said chamber while said body is in engagement with said valve seat.

33. The subsea coupler of claim 32, in which said body defines a reverse seat into which said head fits.

34. The subsea coupler of claim 33, in which said reverse seat is conical in form and said head is formed to complement said conical form of said reverse seat

35. The subsea coupler of claim 32, in which said head includes a rearward part that extends through said body.

36. The subsea coupler of claim 35 and comprising a spring bias between said rearward part of said head and said body to urge said head into contact with said body to close said channel.

37. The subsea coupler of claim 32, and comprising means for urging said poppet against said valve seat.

38. The subsea coupler of claim 32, in which said head is depressible on mating of said subsea coupler with a complementary coupler to move said poppet away from said valve seat.

39. The subsea coupler of claim 32, in which said valve seat is conical and said body of said poppet has a tapered surface complementary to said valve seat.

40. A valve poppet comprising a head, a tapered shoulder for close-fitting engagement with a valve seat, and a body extending rearwardly of said shoulder, wherein said head is separable from said shoulder and is a close fit in a reverse seat formed in said shoulder, said head extending through said reverse seat to a part moveable within said body, and a bleed channel through said body to said reverse seat.

41. The valve poppet of claim 40 and comprising a spring between said part and said body to urge said head and reverse seat together.
